(19) United States
(12) Patent Application Publication
(10) Pub. No.: US 2025/0001371 A1
(43) Pub. Date: Jan. 2, 2025

(54) DETECTING LIQUID TEMPERATURE FOR A BEVERAGE CARBONATION SYSTEM

(71) Applicant: SharkNinja Operating LLC, Needham, MA (US)

(72) Inventors: Walayiding Wailibieke, Beijing (CN); Danny M. Raposo, Lincoln, RI (US); Korkut Bekiroglu, Newtonville, MA (US); Yiming Zhang, Needham, MA (US); Andrew George Terajewicz, Nashville, TN (US); Evan James White, Westwood, MA (US)

(21) Appl. No.: 18/364,776

(22) Filed: Aug. 3, 2023

Related U.S. Application Data
(63) Continuation of application No. PCT/CN2023/104773, filed on Jun. 30, 2023.

(51) Int. Cl. B01F 23/2361; B01F 23/237; B01F 35/21

(52) U.S. Cl. CPC B01F 23/23611; B01F 23/237621; B01F 35/2115

(57) ABSTRACT

Various systems, devices, and methods of detecting liquid temperature for a beverage carbonation system are provided. A carbonation system is one example of a treatment system to which the systems, devices, and methods described herein apply. In general, a carbonation system is configured to form a carbonated fluid by mixing a liquid and a gas and dispensing the carbonated fluid into a container. A temperature of the liquid can be detected, e.g., using a temperature sensor, before the liquid and the gas are mixed together to form the carbonated fluid. A user of the carbonation system can be informed of the liquid's temperature before the mixing begins.

### CROSS-REFERENCE TO RELATED APPLICATIONS

This application is a continuation application, which claims the benefit of Application No. PCT/CN2023/104773, filed on Jun. 20, 2023, entitled “DETECTING LIQUID TEMPERATURE FOR A BEVERAGE CARBONATION SYSTEM” which is hereby also incorporated by reference in its entirety.

### FIELD

The present disclosure generally relates to detecting liquid temperature for a beverage carbonation system.

### BACKGROUND

Various beverage carbonation systems are available that dispense carbonated beverages, for example, carbonated water. In some instances, the carbonated water can be flavored. Consumers can use such beverage carbonation systems in various locations, such as in homes or offices, to carbonate liquid and dispense the carbonated fluid into a container on demand.

To create carbonated fluid, beverage carbonation systems can mix carbon dioxide (CO₂) gas with water in a mixing chamber to dissolve the CO₂ in the water. The dissolution takes place at a significantly elevated pressure to reach the required concentration of dissolved CO₂. The carbonated fluid thereafter exits the mixing chamber for dispensing to a user. However, if the water is at too high a temperature, the dissolution will not occur as effectively as with the water at a lower temperature. The carbonated fluid may therefore have a lower level of carbonation than expected and desired by a user.

Accordingly, there remains a need for improved devices, systems, and methods for carbonation systems.

### SUMMARY

In general, systems, devices, and methods for detecting liquid temperature for a beverage carbonation system are provided.

In one aspect, a system is provided that in one embodiment includes a liquid reservoir configured to supply a liquid to a chamber of a carbonation system configured to form a carbonated fluid in the chamber, a temperature sensor configured to sense a temperature of the liquid, and a processor. The processor is configured to receive a signal from the temperature sensor that is indicative of the sensed temperature, determine, based on the received signal, whether the sensed temperature is below a predetermined threshold temperature, and cause a notification to be provided to a user indicative of whether the sensed temperature is below the predetermined threshold temperature.

The system can have any number of variations. For example, the liquid reservoir can be configured to be releasably coupled to the carbonation system. Further, the system can also include a switch configured to be activated in response to the liquid reservoir being releasably coupled to the carbonation system, and the activation of the switch can be configured to trigger the temperature sensor to transmit the signal to the processor: or the liquid reservoir can be configured to be releasably coupled to the carbonation system, and the releasable coupling of the liquid reservoir to the carbonation system can be configured to close an electrical circuit that includes the temperature sensor and thereby trigger the temperature sensor to transmit the signal to the processor. Further, the temperature sensor can be attached to the liquid reservoir, the liquid reservoir can be configured to be releasably coupled to a dock of the carbonation system such that electrical contacts attached to the liquid reservoir electrically mate with electrical contacts attached to the dock, and the mating of the electrical contacts can close the electrical circuit.

For another example, the liquid reservoir can be integrally formed with the carbonation system.

For yet another example, determining whether the sensed temperature is below the predetermined threshold temperature can include comparing the predetermined threshold temperature with a forecasted future temperature of the liquid, and the processor can be configured to determine the forecasted future temperature based on the received signal. Further, the signal from the temperature sensor can include a plurality of signals each indicative of the temperature of the liquid at a successive time, with the successive times defining a time period, and the forecasted future temperature can be for a time after the time period.

For still another example, determining whether the sensed temperature is below the predetermined threshold temperature can include comparing the predetermined threshold temperature with an actual temperature of the liquid.

For another example, the notification can include at least one of an audible notification and a visual notification. Further, the notification can include at least the visual notification, the visual notification can include a first illuminated light if the sensed temperature is determined to be below the predetermined threshold temperature, and the visual notification can include a second, different illuminated light if the sensed temperature is determined to be above the predetermined threshold temperature; and/or the notification can include at least the visual notification, and the visual notification can include at least one of text and a symbol provided on a user interface. Further, the first light can be in a first color, and the second, different illuminated light can be a second, different color; and/or the first light can be a solid light, and the second, different illuminated light can be a blinking light. Further, the user interface can be on the carbonation system, and/or the user interface can be on an external device configured to be communicatively coupled with the carbonation system.

For still another example, the temperature sensor can include a negative temperature coefficient (NTC) thermistor.

For yet another example, the predetermined threshold temperature can be about 45° F.

In another aspect, a method is provided that in one embodiment includes receiving, at a processor, a signal from a temperature sensor that is indicative of a sensed temperature of a liquid in a liquid reservoir. The liquid in the liquid reservoir is configured to be supplied to a chamber of a beverage carbonation system in which a carbonated fluid is formed. The method also includes determining, using the processor and based on the received signal, whether the sensed temperature is below a predetermined threshold temperature, and causing, using the processor, a notification to be provided to a user indicative of whether the sensed temperature is below the predetermined threshold temperature.

The method can vary in any number of ways. For example, activation of a switch can trigger the temperature sensor to transmit the signal to the processor, the liquid reservoir can be configured to be releasably coupled to the carbonation system, and the switch can be activated in response to the liquid reservoir being releasably coupled to the carbonation system.

For another example, the liquid reservoir can be configured to be releasably coupled to the carbonation system, and the releasable coupling of the liquid reservoir to the carbonation system can close an electrical circuit that includes the temperature sensor and thereby trigger the temperature sensor to transmit the signal to the processor.

For another example, the liquid reservoir can be integrally formed with the carbonation system.

For yet another example, determining whether the sensed temperature is below the predetermined threshold temperature can include comparing the predetermined threshold temperature with a forecasted future temperature of the liquid, and the forecasted future temperature can be determined based on the received signal. Further, the signal from the temperature sensor can include a plurality of signals each indicative of the temperature of the liquid at a successive time, with the successive times defining a time period, and the forecasted future temperature can be for a time after the time period.

For still another example, determining whether the sensed temperature is below the predetermined threshold temperature can include comparing the predetermined threshold temperature with an actual temperature of the liquid.

For another example, the notification can include at least one of an audible notification and a visual notification. Further, the notification can include at least the visual notification, the visual notification can include a first illuminated light if the sensed temperature is determined to be below the predetermined threshold temperature, and the visual notification can include a second, different illuminated light if the sensed temperature is determined to be above the predetermined threshold temperature; and/or the notification can include at least the visual notification, and the visual notification can include at least one of text and a symbol provided on a user interface. Further, the first light can be in a first color, and the second, different illuminated light can be a second, different color; and/or the first light can be a solid light, and the second, different illuminated light can be a blinking light. Further, the user interface can be on the carbonation system, and/or the user interface can be on an external device configured to be communicatively coupled with the carbonation system.

For yet another example, the temperature sensor can include a negative temperature coefficient (NTC) thermistor.

For another example, the predetermined threshold temperature can be about 45° F.

### BRIEF DESCRIPTION OF DRAWINGS

This disclosure will be more fully understood from the following detailed description taken in conjunction with the accompanying drawings, in which:

FIG. 1A is a perspective view of one embodiment of a carbonation system:

FIG. 1B is a perspective view of the carbonation system of FIG. 1A with a gas source chamber cover removed therefrom and with a portion of a liquid source released therefrom:

FIG. 1C is a perspective view of the carbonation system of FIG. 1B with a gas source removed from the gas source chamber:

FIG. 1D is a perspective view of another portion of the carbonation system of FIG. 1B;

FIG. 1E is a perspective view of a portion of the liquid source of FIG. 1B;

FIG. 1F is a perspective exploded view of a portion of the carbonation system of FIG. 1A;

FIG. 1G is a side cross-sectional view of a portion of the carbonation system of FIG. 1A;

FIG. 1H is a perspective cross-sectional view of a portion of the carbonation system of FIG. 1A;

FIG. 1I is a perspective view of one embodiment of a liquid source of a carbonation system;

FIG. 1J is a perspective partial view of the liquid source of FIG. 1I;

FIG. 1K is a perspective view of one embodiment of a base of the carbonation system configured to be used with the liquid source of FIGS. 1I and 1J;

FIG. 1L is a perspective partial view of the carbonation of FIG. 1K;

FIG. 2A is a partial perspective view of another embodiment of a carbonation system;

FIG. 2B is another perspective view of the carbonation system of FIG. 2A;

FIG. 3A is a front view of another embodiment of a carbonation system;

FIG. 3B is a partial perspective view of the carbonation system of FIG. 3A;

FIG. 4 is a schematic view of a communication system including a carbonation system;

FIG. 5A is a flowchart of one embodiment of a method of detecting liquid temperature;

FIG. 5B is a flowchart of one embodiment of the method of FIG. 5A; and

FIG. 5C is a flowchart of another embodiment of the method of FIG. 5A.

### DETAILED DESCRIPTION

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Various illustrative systems, devices, and methods for detecting liquid temperature for a beverage carbonation system are provided. In general, a carbonation system is configured to form a carbonated fluid by mixing a liquid (e.g., water, juice, or other liquid) and a gas (CO₂) and dispense the carbonated fluid into a container, such as a bottle, a cup, or other container. The liquid can be chilled, such as by having ice therein and/or having been stored in a refrigerator prior to being provided to the carbonation system for mixing, so that the resulting carbonated fluid can be at a chilled temperature for drinking. Liquids may therefore be provided to the carbonation system at different temperatures since the liquid may or may not be chilled below room temperature (e.g., may be provided at room temperature or warmer instead of at a chilled temperature) and since different refrigerators can chill liquids to different temperatures. A temperature of the liquid can be detected, e.g., using a temperature sensor, before the liquid and the gas are mixed together to form the carbonated fluid. A user of the carbonation system can be informed of the liquid's temperature before the mixing begins, which may allow the user to know whether the liquid is at a temperature at which the carbonated fluid will be formed effectively. If the liquid is at too high a temperature when mixed with the gas, dissolution of the gas in the liquid will not occur as effectively as with the liquid at a lower temperature. The carbonated fluid may therefore have a lower level of carbonation than expected and desired by a user. Informing the user of the liquid's temperature before mixing begins may therefore allow a user to decide whether to proceed with the carbonated fluid formation process, e.g., because the liquid is at an acceptable temperature, or to not proceed with the carbonated fluid formation process, e.g., because the liquid's temperature is too high and may thus not yield a carbonated fluid having carbonation acceptable to the user.

The systems, devices, and methods described herein are not limited to carbonation systems in which a liquid is mixed with CO₂ to form a treated fluid in the form of a carbonated fluid intended to be a beverage. A beverage carbonation system is one example of a treatment system to which the systems, devices, and methods described herein apply. Other treatment systems are generally configured and used similar to the carbonation systems described herein except instead of mixing CO₂ with a liquid, a different gas is mixed with the liquid. The resulting fluid is a treated fluid but is not a “carbonated” fluid. Additionally, systems, devices, and methods described herein are not limited to treatment systems in which a liquid is mixed with gas to form a treated fluid. The systems, devices, and methods described herein also apply to beverage systems configured to dispense a still liquid beverage.

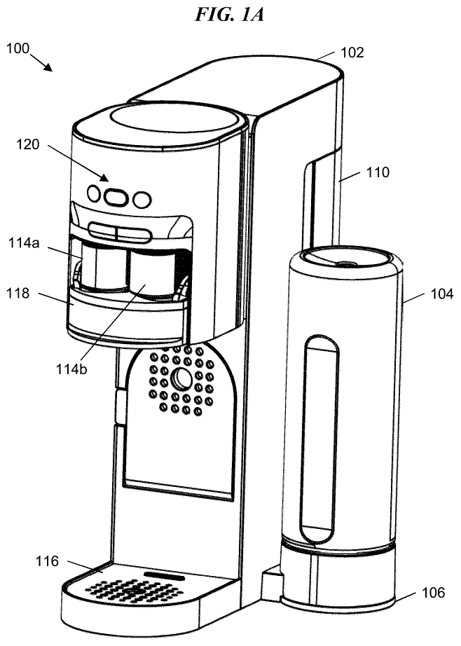

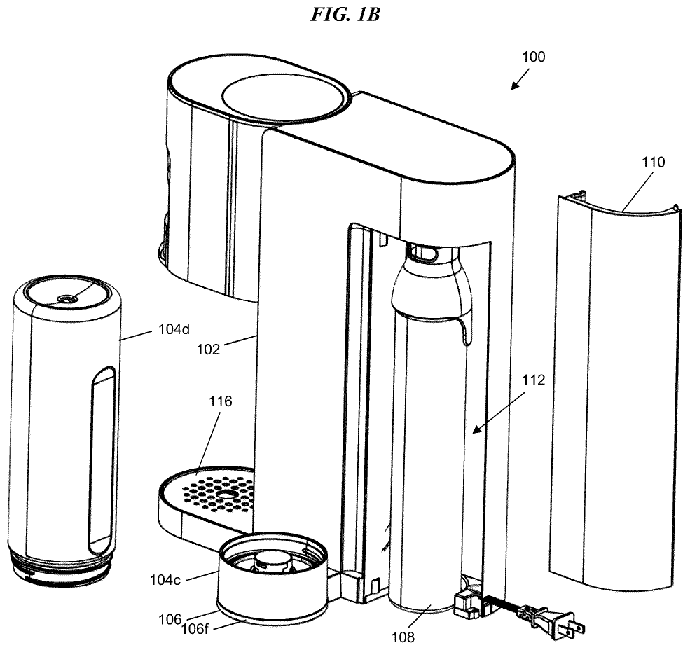

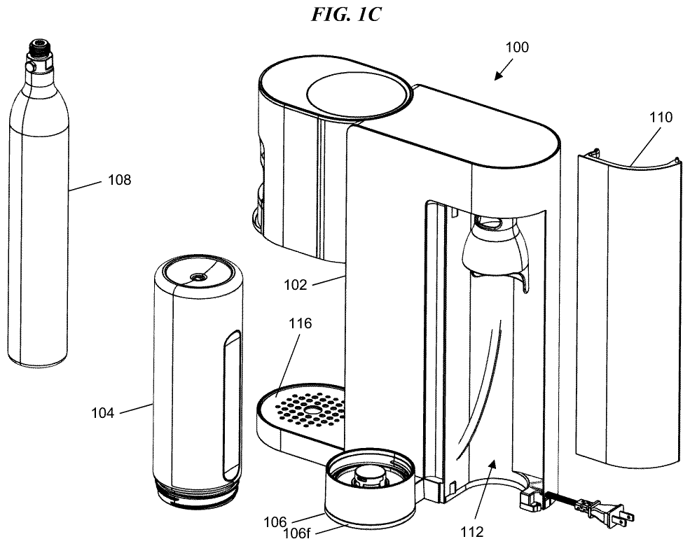

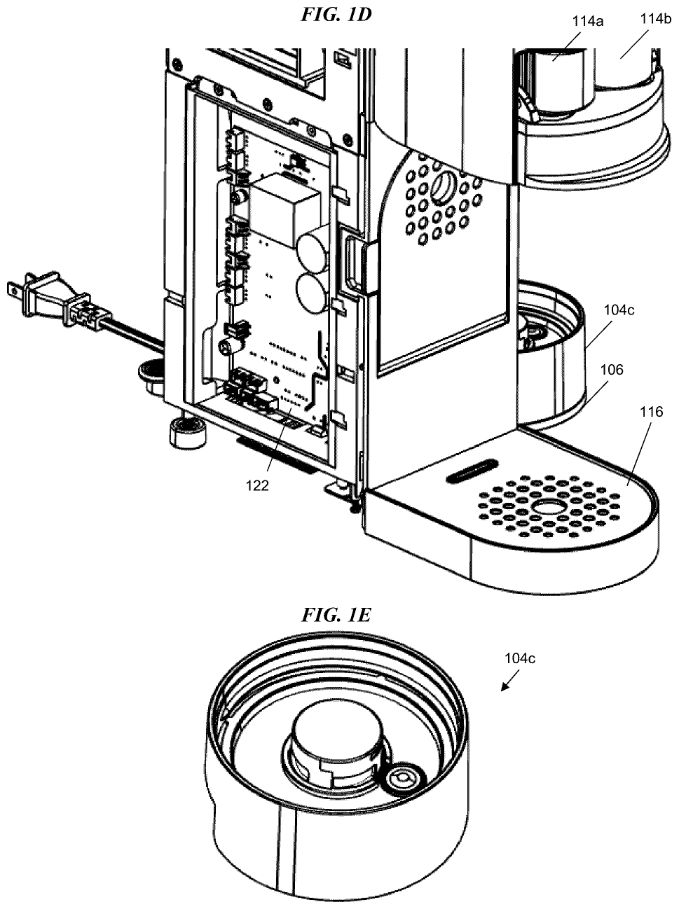

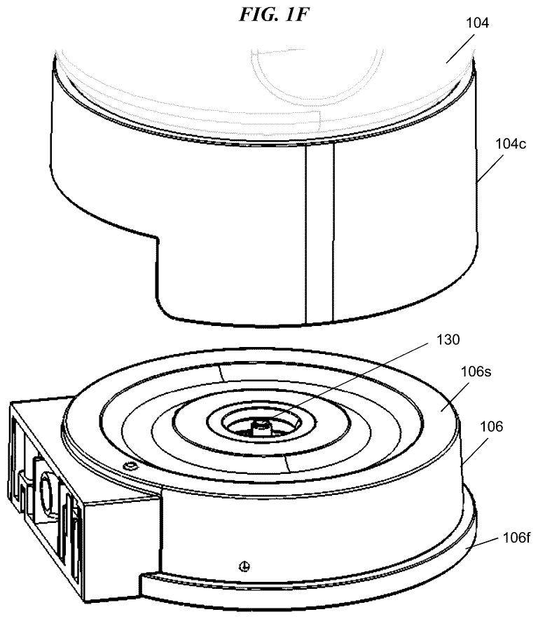

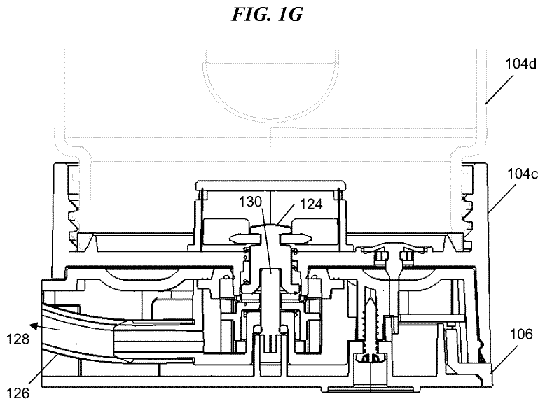

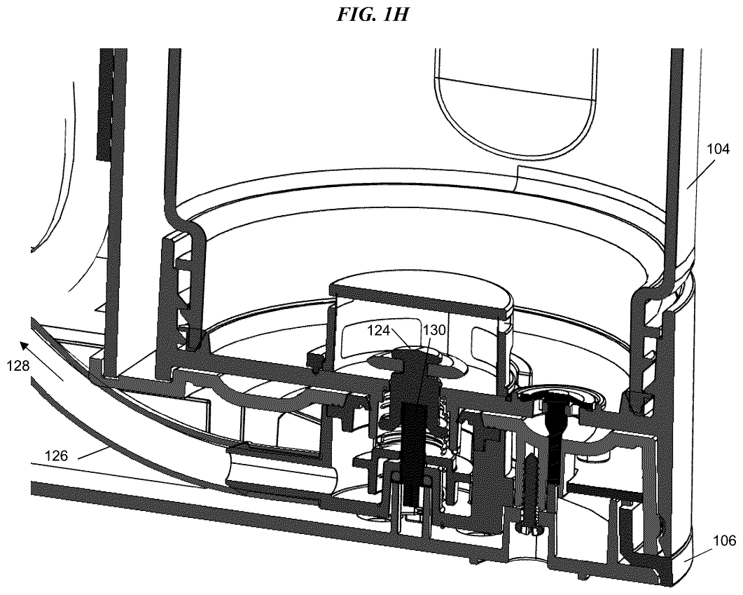

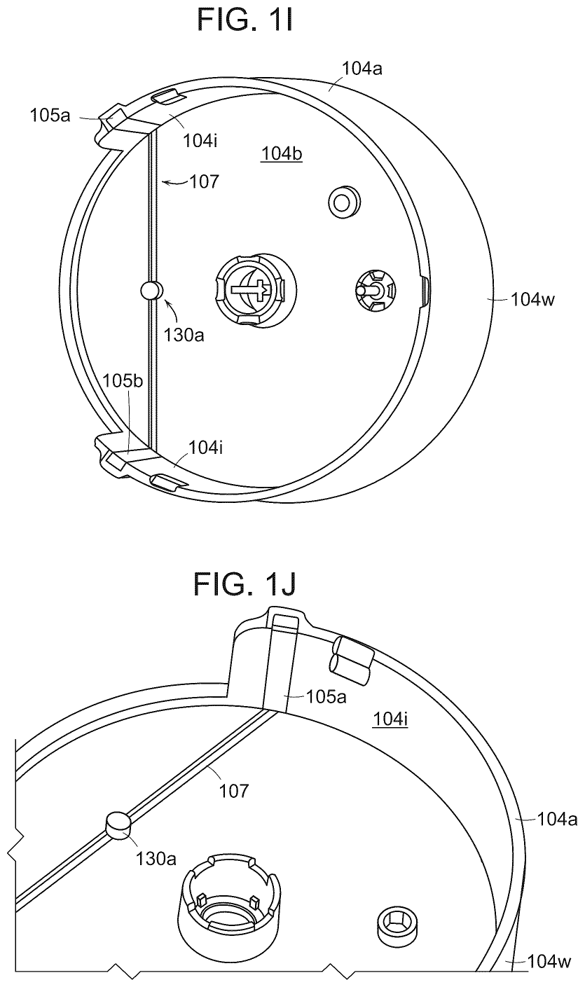

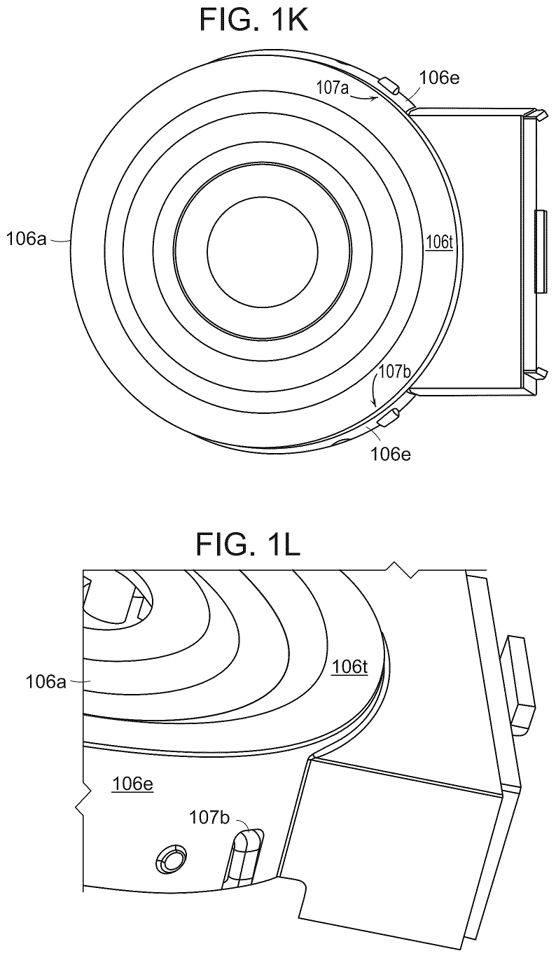

FIGS. 1A-IC illustrate one embodiment of a carbonation system 100 configured to form a carbonated fluid. The carbonation system 100 includes a housing 102 in which various components of the carbonation system 100 are housed.

The carbonation system 100 includes a liquid source (also referred to herein as a “liquid reservoir”) 104 in the form of a bottle configured to be releasably coupled to the carbonation system 100. Other liquid sources can be used, and the liquid source 104 can have any of a variety of configurations. In this illustrated embodiment, the liquid source 104 is configured to mate with a dock (also referred to herein as a “base”) 106 by being placed into contact therewith. Other mating configurations are possible, such as with threading in which a thread of the liquid source 104 threading with a thread of the dock 106, a bayonet connection, a press fit, a hinged connection, etc. FIGS. 1A, 1G, and 1H show the liquid source 104 removably coupled to the carbonation system 100 via the base 106. FIGS. 1B-1D show a body 104d of the liquid source 104 as a standalone element not coupled to the carbonation system 100 and a cap 104c of the liquid source 104 coupled to the carbonation system 100. FIG. 1E shows the cap 104c of the liquid source 104 as a standalone element. In some embodiments, the liquid source can be integral to the carbonation system 100, such as by being a built-in refillable tank or other refillable reservoir, instead of being configured to releasably couple to the carbonation system 100. Various embodiments of carbonation systems configured to be in selective fluid communication with a liquid source are described, for example, in U.S. patent application Ser. No. 17/744,459 entitled “Flavored Beverage Carbonation System” filed May 13, 2022, U.S. patent application Ser. No. 17/989,640 entitled “Ingredient Containers For Use With Beverage Dispensers” filed Nov. 17, 2022, and U.S. patent application Ser. No. 18/099,690 entitled “Venting A Chamber In A Beverage Carbonation System” filed Jan. 20, 2023, which are hereby incorporated by reference in their entireties.

As discussed herein, the carbonation system 100 can be configured to detect a temperature of liquid in the liquid source 104 and to provide a notification of the detected temperature.

The gas source 108 is configured to be removably coupled to the carbonation system 100. The gas source 108 in this illustrated embodiment is in the form of a CO₂ canister. A gas source chamber cover 110 that forms part of and is releasably coupled to the housing 102 is released from the housing 102 in FIGS. 1B and 1C to show a gas source chamber 112 of the carbonation system 100 that is configured to removably receive the gas source 108 therein. The gas source chamber cover 110 in this illustrated embodiment is shown as being completely releasable from the housing 102, but in other embodiments can be partially releasable so as to open and provide access to the gas source chamber 112, e.g., by being a hinged door, by being slidable into a portion of the housing 102, etc. FIG. 1B shows the gas source 108 located in the gas source chamber 112 and removably coupled to the carbonation system 100. FIG. 1C shows the gas source 108 as a standalone element located outside of the gas source chamber 112 and not coupled to the carbonation system 100. Other gas sources can be used. Various embodiments of gas sources and carbonation systems configured to releasably receive gas sources are further described, for example, in previously mentioned U.S. patent application Ser. No. 18/099,690 entitled “Venting A Chamber In A Beverage Carbonation System” filed Jan. 20, 2023.

The liquid supplied to the mixing chamber of the carbonation system 100 can be mixed with CO₂ supplied to the mixing chamber from a gas source 108 to form the carbonated fluid. Various embodiments of mixing chambers and agitators configured to be disposed in mixing chambers are described, for example, in Intl. Pat. App. No. PCT/CN2022/092688 entitled “Agitator For A Carbonation System” filed May 13, 2022, which is hereby incorporated by reference in its entirety.

The carbonation system 100 in this illustrated embodiment is configured to selectively dispense first and second additives from first and second consumables 114a, 114b, respectively, into a container (not shown) placed on a container base 116 of the carbonation system 100 that can also serve as a drip tray. Each of the first and second consumables 114a, 114b can include one or more additives including any of a variety of ingredients, including, for example, flavorants, colorants, vitamins, minerals, chemicals, other ingredients, or any suitable combination of the foregoing. The carbonation system 100 includes a carriage assembly 118 configured to receive the first and second consumables 114a, 114b. However, the carbonation system 100 can be configured to add no additive or to add a different number of additives.

The carbonation system 100 can be configured to allow a user to select, e.g., via a user interface 120, which one or both of the first and second additives is dispensed into a cup, a bottle, or other container (not shown in FIGS. 1A-1C) and/or to allow the user to select an amount of the selected additive(s) to be dispensed into the container. The user may select no additive. The selected additive(s) can be dispensed into the container before the carbonated fluid is dispensed, after the carbonated fluid is dispensed, or simultaneously with the dispensing of the carbonated fluid. Various embodiments of carbonation systems configured to add additive(s) are described, for example, in U.S. patent application Ser. No. 17/744,459 entitled “Flavored Beverage Carbonation System” filed May 13, 2022 and U.S. patent application Ser. No. 17/989,640 entitled “Ingredient Containers For Use With Beverage Dispensers” filed Nov. 17, 2022, which are hereby incorporated by reference in their entireties.

The user interface 120 is configured to receive input from a user regarding one or more aspects of the carbonation system 100 (e.g., volume of carbonated fluid to be dispensed, carbonation level, specific additives, additive amount, etc.) and/or configured to provide alerts (e.g., audible and/or visual) regarding one or more aspects of the carbonation system 100 (e.g., status of whether the carbonation fluid has finished being dispensed from the carbonation system 100, a temperature of the liquid in the liquid source 104, power on/off status of the carbonation system 100, etc.).

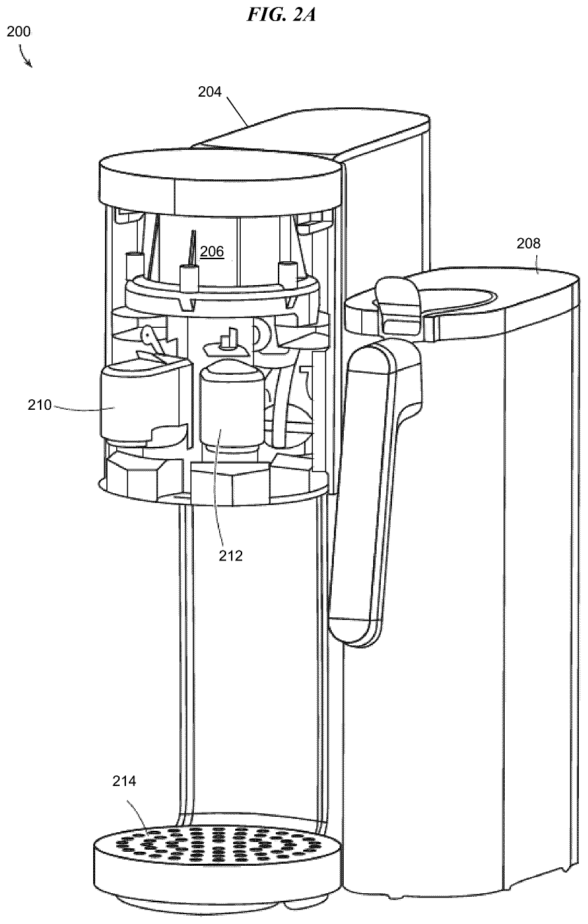

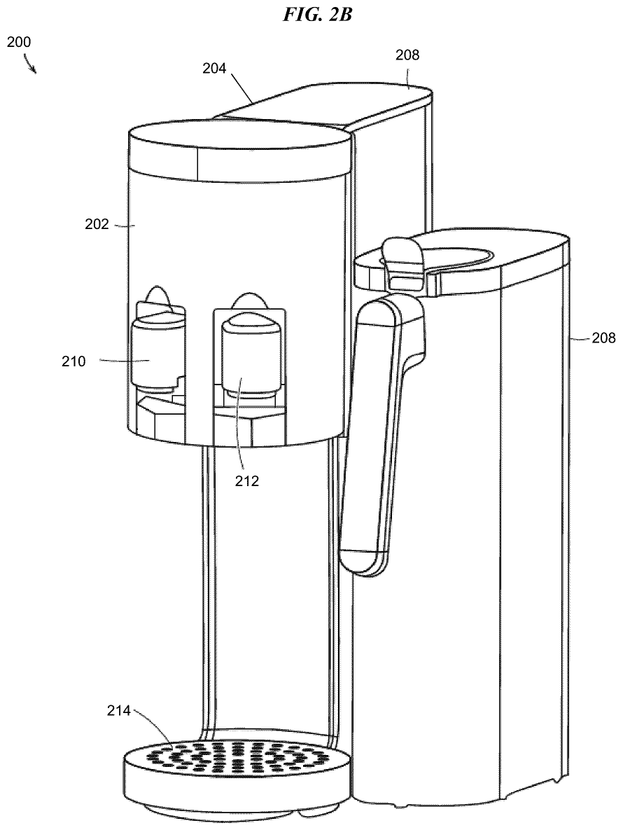

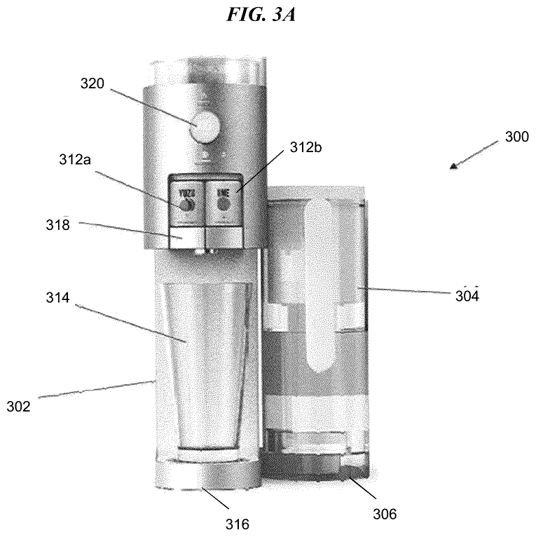

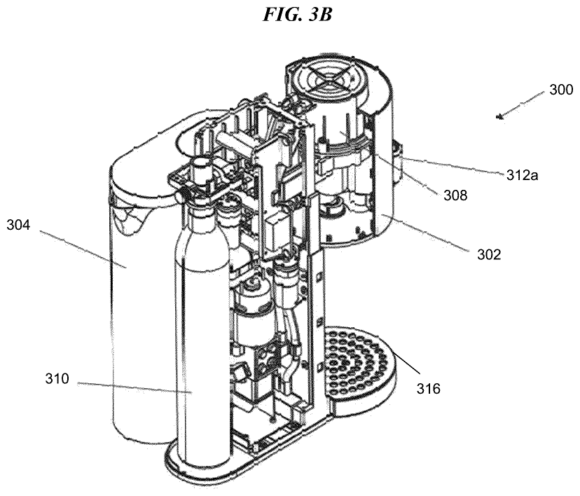

As shown in FIG. 1D, the carbonation system 100 also includes a printed circuit board (PCB) 122 disposed in the housing 102 and including various components, such as a processor (e.g., a microcontroller that includes a processor and a memory, or other type of processor) and a memory, configured to facilitate operation of the carbonation system 100. The PCB 122 can have a variety of configurations and, in some embodiments, the processor can be included in the carbonation system 100 without use of a PCB. In general, the processor is configured to execute instructions stored in the memory to cause various actions to occur, such as opening of an outlet valve of the carbonation system 100 to dispense carbonated fluid, causing the first additive(s) to be dispensed from the first additives) consumable 114a, causing the second additive(s) to be dispensed from the second consumable 114b, causing an alert (e.g., an illuminated (solid or blinking) light, an emitted sound, etc.) to be provided to a user when the carbonation fluid has finished being dispensed from the carbonation system 100, causing an alert (e.g., an illuminated light, an emitted sound, etc.) to be provided to a user when a temperature of the liquid in the liquid source is below a threshold minimum temperature and/or is above a threshold maximum temperature, etc. Other embodiments of treatment systems (e.g., a carbonation system 200 of FIGS. 2A-2B, a carbonation system 300 of FIGS. 3A-3B, etc.) described herein similarly include a processor.

FIGS. 2A and 2B illustrate another embodiment of a carbonation system 200 configured to form a carbonated fluid. A cover 202 that forms part of a housing 204 of the carbonation system 200 is omitted in FIG. 2A to show a mixing chamber 206 of the carbonation system 200. The carbonation system 200 can have a variety of configurations, such as a configuration similar to the carbonation system 100 of FIG. 1A-1C, or other carbonation system. As discussed herein, the carbonation system 200 can be configured to detect a temperature of liquid in the liquid source 208 and to provide a notification of the detected temperature.

The carbonation system 200 includes a liquid source 208 in the form of a pitcher configured to be releasably coupled to the carbonation system 200 via a dock (not shown). Other liquid sources can be used, and the pitcher 208 can have any of a variety of configurations. A check valve (or other type of valve) can be configured to automatically open in response to the pitcher 208 being seated in the dock to allow liquid, e.g., water, in the pitcher 208 to flow out of the pitcher 208 and into the chamber 206. In some embodiments, the liquid reservoir can be integral to the carbonation system 200, such as by being a built-in refillable tank or other refillable reservoir, instead of being configured to releasably couple to the carbonation system 200.

The carbonation system 200 in this illustrated embodiment is configured to selectively dispense first and second additives from first and second consumables 210, 212, respectively, into a container placed on a container base 214 of the carbonation system 200 that can also serve as a drip tray. However, as discussed above, the carbonation system 200 can be configured to add no additive or to add a different number of additives.

FIGS. 3A and 3B illustrate another embodiment of a carbonation system 300 configured to form a carbonated fluid. A portion of a housing 302 of the carbonation system 300 is omitted in FIG. 3B to show an interior of the carbonation system 300. The carbonation system 300 can have a variety of configurations, such as a configuration similar to the carbonation system 100 of FIGS. 1A-1C, the carbonation system 200 of FIG. 2A-2B, or other carbonation system. As discussed herein, the carbonation system 300 can be configured to detect a temperature of liquid in the liquid source 304 and to provide a notification of the detected temperature.

The carbonation system 300 includes a liquid source 304 in the form of a pitcher configured to be releasably coupled to the carbonation system 300 via a dock 306. Other liquid sources can be used, and the pitcher 304 can have any of a variety of configurations. A check valve can be configured to automatically open in response to the pitcher 304 being seated in the dock 306 to allow liquid, e.g., water, in the pitcher 304 to flow out of the pitcher 304 and into a mixing chamber 308 of the carbonation system 300. In some embodiments, the liquid reservoir can be integral to the carbonation system 300, such as by being a built-in refillable tank or other refillable reservoir, instead of being configured to releasably couple to the carbonation system 300.

The carbonation system 300 also includes a gas source 310 in the form of a CO₂ canister configured to be removably coupled to the carbonation system 300. Other gas sources can be used, and the CO₂ canister 308 can have any of a variety of configurations.

The mixing chamber 308 is configured to receive liquid therein through a liquid inlet (obscured in the figures) operably coupled to the liquid source 304 (e.g., through liquid tubing and/or other components) and is configured to receive gas therein through a gas inlet (obscured in the figures) operably coupled to the gas source 310 (e.g., through gas tubing and/or other components).

The carbonation system 300 in this illustrated embodiment is configured to selectively dispense first and second additives from first and second consumables 312a, 312b, respectively, into a container 314 (shown as a cup in this illustrated embodiment) placed on a container base 316 of the carbonation system 300 that can also serve as a drip tray. The carbonation system 300 includes a carriage assembly 318 configured to receive the first and second consumables 312a, 312b. However, as discussed above, the carbonation system 300 can be configured to add no additive or to add a different number of additives.

The carbonation system 300 includes a user interface 322 configured to receive input from a user regarding one or more aspects of the carbonation system 300 (e.g., volume of carbonated fluid to be dispensed, carbonation level, specific additives, additive amount, etc.) and/or configured to provide alerts (e.g., audible and/or visual) as described herein to the user regarding one or more aspects of the carbonation system 300 (e.g., status of whether the carbonation fluid has finished being dispensed from the carbonation system 300, a temperature of the liquid in the liquid source 304, power on/off status of the carbonation system 300, etc.).

Carbonation systems such as the carbonation system 100 of FIGS. 1A-ID, the carbonation system 200 of FIGS. 2A-2B, and the carbonation system 300 of FIGS. 3A-3B can be configured to detect a temperature of liquid in a liquid source that is coupled to the carbonation system. The carbonation system can also be configured to provide a notification indicative of the detected temperature. A user can therefore be notified whether or not the liquid is at a desirable temperature for formation of a carbonated fluid or at a temperature at which the carbonated fluid's carbonation level may be less than expected or desired.

One embodiment of a carbonation system configured to detect a temperature of liquid in a liquid source and provide a notification indicative of the detected temperature is described below with respect to the carbonation system 100 of FIGS. 1A-1H but other carbonation systems and treatment systems (e.g., the carbonation system 200 of FIGS. 2A-2B, the carbonation system 300 of FIGS. 3A-3B, and other systems) can be similarly configured.

As mentioned above, the liquid source 104 is configured to be releasably coupled to the carbonation system 100. The liquid contained in the liquid source 104 is configured to automatically flow into the carbonation system 100 in response to coupling of the liquid source 104 to the carbonation system 100, e.g., to the base 106 of the carbonation system 100. As shown in FIGS. 1G and 1H, the carbonation system 100 at the dock 106 includes a check valve 124 configured to automatically open in response to the liquid source 104 being seated in the dock 106. The check valve 124 being open allows the liquid in the liquid source 104 to flow out of the liquid source 104 and through a liquid flow tube 126 in a direction shown by an arrow 128 toward the mixing chamber. The carbonation system 100 includes a liquid pump (obscured in the figures) configured to urge the liquid to flow toward the mixing chamber.

The carbonation system 100 includes a temperature sensor 130 configured to detect a temperature of liquid that flows out of the liquid source 104 and into the carbonation system 100. The temperature sensor 130 is configured to measure the temperature of the liquid outside of the liquid source 104, but the detected temperature corresponds to the temperature of the liquid contained in the liquid source 104 since the temperature sensor 130 measures the liquid's temperature proximate to the check valve 124 through which the liquid enters into the carbonation system 100. The temperature sensor 130 in this illustrated embodiment includes a negative temperature coefficient (NTC) thermistor, but another type of temperature sensor can be used, such as a laser temperature sensor, an infrared temperature sensor, a thermometer, a strain gauge, or other type of temperature sensor. The temperature sensor 130 is a single sensor in this illustrated embodiment but can include a plurality of temperature sensors.

The temperature sensor 130 is configured to be communicatively coupled with the processor of the carbonation system 100. The temperature sensor 130 is configured to transmit a signal to the processor indicative of the temperature sensed by the temperature sensor.

The carbonation system 100 includes an activator configured to be activated in response to the liquid source 104 being releasably coupled to the base 106. The activator (obscured in the figures) is a microswitch in this illustrated embodiment but could be in another form, such as another type of switch, a Hall effect sensor, a light sensor, a laser, or other activator. The seating of the liquid source 104 on the base 106 is configured to automatically activate the activator. The user therefore does not need to perform any special action to cause activation of the activator since the user is already seating the liquid source 104 on the base 106 to use the carbonation system 100. Release of the liquid source 104 from the base 106 is configured to automatically deactivate the activator, thereby readying the activator to be activated again at a later time in response to the liquid source 104 being coupled again to the base 106.

The activator is configured to be communicatively coupled with the processor. The activation of the activator is configured to trigger the activator to transmit a signal to the processor indicative of the liquid source 104 being coupled to the carbonation system 100, e.g., to the base 106. In response to receipt of the signal from the activator, the processor is configured to transmit a signal to the temperature sensor 130 that triggers the temperature sensor 130 to begin transmission of signal(s) to the processor indicative of temperature measured by the temperature sensor 130. The temperature sensor 130 can therefore be configured to transmit liquid temperature information to the processor only in response to a liquid source 104 being coupled to the carbonation system 100 instead of continuously transmitting temperature information to the processor when there is no liquid source 104 coupled to the carbonation system 100 and/or after the processor has already determined the liquid's temperature based on the signal(s) from the temperature sensor 130.

In other embodiments, in response to receipt of the signal from the activator, the processor can be configured to cause liquid to be pumped out of the liquid source 104 toward the carbonation system's mixing chamber. The liquid will thus pass by the temperature sensor 130 en route to the mixing chamber, thereby allowing the temperature sensor 130 to measure a temperature of the liquid. This pumping cycle can be very short, such as one millisecond or another amount of time, so that only a very small amount of liquid is pumped toward the mixing chamber for purposes of temperature measurement.

The processor is configured to use the sensed temperature in determining whether the liquid's temperature is below a predetermined threshold temperature. The predetermined threshold temperature reflects a temperature above which a carbonated fluid formed using the liquid may have a lower level of carbonation than expected and desired by a user. For example, the predetermined threshold temperature can be in a range of 32° F. or greater. For another example, the predetermined threshold temperature can be in a range of 45° F. to 47° F. e.g., 45° F. 45.5° F. 46° F. 46.5° F. 47° F., etc. For another example, the predetermined threshold temperature can be in a range of 32° F. to 47° F. e.g., 33° F. 35° F. 38° F. 45° F. 45.5° F. 46° F. 46.5° F. 47° F., etc. As discussed further below, the processor can make such a determination in a variety of ways.

In some embodiments, an actual temperature of the liquid is considered by the processor in determining whether the liquid's temperature is below the predetermined threshold temperature. In such embodiments, the processor is configured to compare the sensed temperature, as indicated by one or more signals from the temperature sensor 130, with the predetermined temperature threshold to determine whether the liquid's temperature is below the predetermined threshold temperature. Considering an actual temperature of the liquid may help ensure that the temperature of the liquid being mixed with CO₂ to form a carbonated fluid is actually below the predetermined threshold temperature and that, therefore, the carbonated fluid will have an expected desired level of carbonation.

NTC thermistors (and other types of temperature sensors) traditionally take a number of seconds, e.g., about 10 to about 12 seconds, to accurately detect a temperature. It can thus take the temperature sensor 130, an NTC thermistor (or other type of temperature sensor with a sensing delay), a number of seconds, e.g., about 10 to about 12 seconds, to accurately detect a temperature of the liquid. Some NTC thermistors can take less time to accurately detect a temperature of the liquid, e.g., about 0.5 seconds. A person skilled in the art will appreciate that a value may not be precisely at a value but nevertheless considered to be about that value due to any number of factors, such as sensitivity of measurement equipment. A user having to wait this number of seconds before receiving an indication of the liquid's temperature can be an unacceptable delay from the user's perspective since it delays a start of forming the carbonated fluid. Additionally, the user may not be able to tell that anything is happening at the carbonation system 100 while the liquid's temperature is being detected, which may further frustrate the user and degrade the user's experience of using the carbonation system 100.

In some embodiments, the processor is configured to consider a forecasted temperature of the liquid in determining whether the liquid's temperature is below the predetermined threshold temperature. In such embodiments, the processor is configured to use the sensed temperature, as indicated by one or more signals from the temperature sensor 130, in determining a forecasted temperature of the liquid. The forecasted temperature of the liquid predicts what the temperature of the liquid will be at a future time. The forecasted temperature can be determined more quickly than waiting for the temperature sensor 120, when an NTC thermistor (or other types of a temperature sensor with a sensing delay), to detect an actual temperature of the liquid. The forecasted temperature can be determined in a range of about 2 seconds to about 4 seconds (e.g., about 3 seconds, about 3.3 seconds, or other time), which is faster than the about 10 to about 12 seconds it can take to detect actual temperature. In such embodiments, the processor is configured to compare the forecasted temperature with the predetermined temperature threshold to determine whether the liquid's temperature is below the predetermined threshold temperature. A user can therefore receive an indication of the liquid's temperature faster and thus have a better user experience using the carbonation system 100.

The processor is configured to use a forecasting model in determining the forecasted temperature. The forecasting model can be stored in a memory configured to be accessible by the processor. One embodiment of a forecasting model is:

$${τ}_{A + 1} = ( A * {τ}_{K} ) + ( B * {τ}_{K - 1} ) + ( C * {τ}_{K - 2} ) + ( D * {τ}_{K - 3} )$$

where τ_{A+1} is predicted temperature in the next second. TK is the temperature at a time K, and A, B, C, and D are constant values. There are four constant values in the forecasting model to reflect the determination of a forecasted temperature being made using four temperatures sensed by the temperature sensor 130, with one temperature being detected about every one second (e.g., times K, K-1, K-2, and K-3) such that the processor receives indications of four sensed temperatures. In one embodiment, A is a constant value of 1.0143, B is a constant value of 0.2149, C is a constant value of −0.0817, D is a constant value of −0.1475. In another embodiment, A is a constant value of 0.9415, B is a constant value of 0.1414, C is a constant value of 0.2486, D is a constant value of −0.3472. The coefficients can be re-trained if desired. Also based on the forecasting performance, the number of historical temperature readings can be increased or decreased. As demonstrated by each of these two examples, the constant values A, B, C, and D are lower for each older temperature to give more weight to more recently detected temperatures, constant value A that is multiplied by the temperature detected at time K is greater than constant value B that is multiplied with the temperature detected about one second earlier at time K−1, etc.

The processor can be configured to execute the forecasting model one time or a plurality of times. Each execution of the forecast model predicts temperature further in the future. For example, executing the forecasting model three times can predict the what the temperature will be in about 35 seconds.

The processor is configured to provide a notification to a user indicative of whether the sensed temperature (which can be either the actual temperature or the forecasted temperature, as discussed above) is below the predetermined threshold temperature. The notification can be audible and/or visual. The audible notification can be in any of a variety of forms, such as a voice announcement of the liquid temperature, a voice announcement that the liquid temperature is acceptable, a voice announcement that the liquid temperature is not acceptable, one or more beeps to indicate an unacceptable liquid temperature, and other forms of audible notifications. The visual notification can be in various forms, such as a display of text and/or graphics indicating whether or not the liquid temperature is acceptable, a light indicating whether or not the liquid temperature is acceptable, and other forms of visual notifications.

In embodiments in which a light is used to indicate liquid temperature acceptability to a user, a first light can be illuminated if the liquid temperature is determined to be below the predetermined threshold temperature, and a second, different light can be illuminated if the sensed temperature is determined to be above the predetermined threshold temperature. The first light can be in a first color (e.g., blue or other color), and the second, different illuminated light can be a second, different color (e.g., orange or other color), and/or the first light can be a solid (e.g., continuously illuminated) light, and the second, different illuminated light can be a blinking light.

The notification can be configured to be provided for a predetermined amount of time (e.g., ten seconds or another amount of time) and then stop being provided. The predetermined amount of time is an amount of time in which the user is presumed to have adequate time to see the notification. Stopping the provision of the notification after a predetermined amount of time has passed since the notification began being provided may help prolong the life of the component(s) used in providing the notification, such as by having light(s) illuminated for relatively short periods of time every time the liquid source 104 is releasably coupled to the base 106.

Instead of the notification being provided for a predetermined amount of time, the notification can be configured to be provided until acknowledged by the user via an input to the carbonation system 100. Requiring acknowledgment of the notification may help ensure that the user is aware of the liquid temperature being acceptable or not before the user initiates formation of a carbonated fluid using the liquid, such as by pressing a start button on the user interface 120) or otherwise starting the carbonated fluid formation process. In some embodiments, the acknowledgment may not be required before the carbonated fluid formation process, in which case the notification can be stopped in response to the start of the carbonated fluid formation process. The user interface 120 can be configured to receive the acknowledgment input, such as by the user pressing a button, touching an acknowledgment prompt on a touchscreen, or providing another input to the user interface 120. In embodiments in which the notification is provided via an external device, as discussed below; the input can be provided to the external device.

The notification can be provided via the carbonation system 100, such as via the user interface 120 of the carbonation system 100. For example, in embodiments in which a light is used to indicate liquid temperature acceptability to a user, the user interface 120 can include one or more lights configured to illuminate to provide the notification. For another example, in embodiments in which an audible notification is provided to a user, the user interface 120 can include a speaker via which the audible notification is provided. For yet another example, in embodiments in which a textual and/or graphical notification is provided, the user interface 120 can include a display configured to show the text and/or graphics thereon.

In addition to or instead of the carbonation system 100 providing the notification via the user interface 120, the carbonation system 100 can be configured to provide the notification as a visual notification at the base 106 of the carbonation system 100. The liquid source 104 seats on the base 106, as discussed above, so providing the notification at the base 106 provides the notification near the liquid source 104 and is thus a location for the notification that the user may intuitively understand to be a notification regarding the liquid.

The light can be located at various locations at the base 106. In some embodiments, the light can include one or more lights, e.g., LEDs (such as individual LEDs or an LED strip or pipe), and/or other type of lights, in a foot 106f of the base 106 and configured to shine through the foot 106f. The one or more lights can thus be configured to shine radially outwardly to illuminate the foot in a color indicative of the liquid temperature. The foot 106f can be formed of a semi-transparent or transparent material to facilitate visualization of the illumination.

In some embodiments, the light can include one or more lights, e.g., LEDs (such as individual LEDs or an LED strip or pipe) and/or other types of lights, configured to shine upwardly toward where the liquid source 104 is configured to be seated on the base 106. The light(s) can thus be configured to be visible at the base 106 and at the liquid source 104 coupled to the base 106. The base 106 and at least a lower portion of the liquid source 104 can be formed of a semi-transparent or transparent material to facilitate visualization of the illumination. For example, a light configured to shine upwardly toward where the liquid source 104 is configured to be seated on the base 106 can include an LED pipe attached to a first upwardly facing surface 106s of the base 106 (see FIG. 1F). For another example, a light configured to shine upwardly toward where the liquid source 104 is configured to be seated on the base 106 can include an LED pipe attached to a second upwardly facing surface 106u of the base 106 (see FIG. 1E).

In addition to or instead of the carbonation system 100 providing the notification via the user interface 120 and/or at the base 106, the carbonation system 100 can be configured to provide the notification as a visual notification via a liquid filter of the carbonation system 100. The liquid that flows out of the liquid source 104 and into the carbonation system 100 is configured to flow through the liquid filter. In some embodiments, the liquid filter can be thermochromatic, e.g., formed of one or more thermochromatic materials. Such a thermochromatic filter is configured to change color in response to temperature. Thus, a color of the thermochromatic filter can indicate whether or not the liquid temperature is acceptable, e.g., a first color for an unacceptable temperature and a second color (or a different shade of the first color) for an acceptable temperature, by changing color when the liquid passes through the filter.

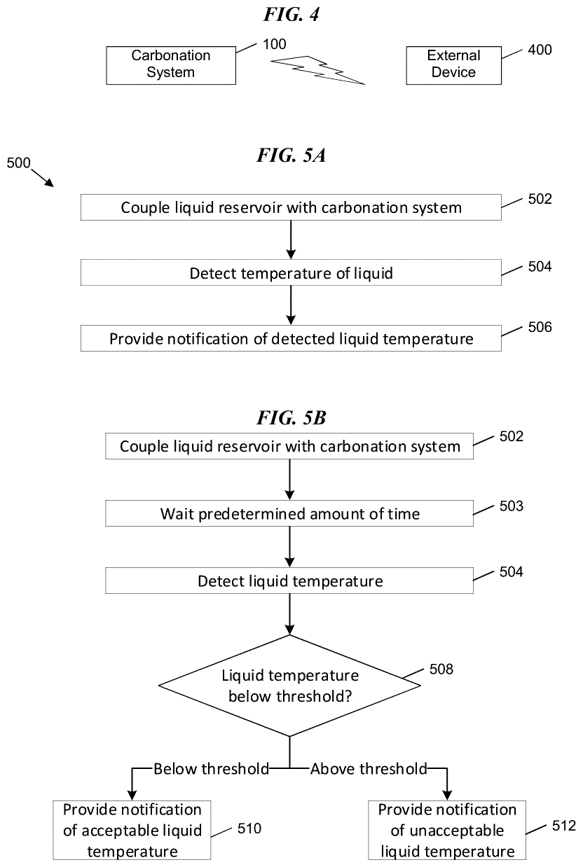

In addition to or instead of the carbonation system 100 providing the notification, the notification can be provided via an external device 400 configured to be communicatively coupled with the carbonation system 100, as shown in FIG. 4. The carbonation system 100 and the external device 400 can be communicatively coupled in any of a variety of ways, such as with a wireless connection (e.g., Bluetooth or other wireless connection). The external device 400 can be any of a variety of types of devices, such as a mobile phone, a laptop, a smartwatch, a tablet computer, or other devices. The external device 400 can have an application (app) installed thereon configured to facilitate the external device 400 providing the notification, such as by the external device 400 being configured to receive a signal from the carbonation system 100 that triggers the external device 400, via the app, to provide the audible and/or visual notification via a user interface of the external device 400).

Another embodiment of a carbonation system configured to detect a temperature of liquid in a liquid source and provide a notification indicative of the detected temperature is described below with respect to a carbonation system of FIGS. 1I-IL but other carbonation systems and treatment systems (e.g., the carbonation system 200 of FIGS. 2A-2B, the carbonation system 300 of FIGS. 3A-3B, and other systems) can be similarly configured. The carbonation system of FIGS. 1I-IL is configured similar to the carbonation system 100 of FIGS. 1A-1H and is thus not specifically described except as discussed below with respect to aspects of the carbonation system related to temperature detecting.

In the carbonation system of FIGS. 1I-IL a liquid source 104a includes a temperature sensor 130a instead of the base 106 including a temperature sensor 130 as in the carbonation system 100 of FIGS. 1A-1H. The liquid source 104a including the temperature sensor 130 may shorten response time of liquid temperature measurement because, unlike an embodiment such as that of the illustrated carbonation system 100 of FIGS. 1A-1H, no liquid in the liquid source 104a has to flow out of the liquid source 104a before temperature of the liquid can be measured. User experience may therefore be improved by decreasing an amount of time the user waits before receiving notification of the liquid's temperature.

The liquid source 104a shown in FIGS. 1I and 1J is configured to releasably couple to a base 106a similar to that discussed above regarding the liquid source 104 and the base 106 of the carbonation system 100 of FIGS. 1A-1H. The liquid source 104a in this illustrated embodiment is not and cannot be integral to the carbonation system because, as discussed further below, coupling the liquid source 104a with the base 106a is configured to trigger the temperature sensor 130a to detect temperature of the liquid contained in the liquid source 104a.

As in this illustrated embodiment, the temperature sensor 130a can be attached to a bottom surface 104b of the liquid source 104 that defines a bottom of an interior container portion of the liquid source 104a. The liquid source's interior container portion is obscured in FIGS. 1I and 1J but is an inner portion of the liquid source defined by an outer wall 104w of the liquid source 104a. The temperature sensor 130a extends upward from the bottom surface 104b so as to be configured to be in direct contact with liquid contained in the interior container portion of the liquid source 104a. Liquid in the liquid source 104a therefore does not have to flow out of the liquid source 104a before temperature of the liquid can be measured because, with the liquid source containing liquid, the temperature sensor 130a is in direct contact with liquid in the liquid source 104a. Because the temperature sensor 130a is located at a bottom of the liquid source 104a, e.g., at the bottom of the interior container portion, the temperature sensor 130a can be in direct contact with liquid in the liquid source 104a regardless of how much liquid is in the liquid source 104a since the liquid will settle to the bottom of the liquid source 104a, due to gravity, with the liquid source 104a mated with the base 106a. In other embodiments, the liquid source's temperature sensor 130a can be located elsewhere, such as attached to the outer wall 104w of the liquid source 104a and extending radially inward so as to be configured to be in direct contact with liquid contained in the interior container portion of the liquid source 104a.

The liquid source 104a includes first and second electrical contacts 105a. 105b and first and second electrical connectors 107a. 107b. The first and second electrical connectors 107a. 107b are operatively coupled to the temperature sensor 130a. The first wire 107a is operatively coupled to the first electrical contact 105a and extends therefrom to the temperature sensor 130a. The second wire 107b is operatively coupled to the second electrical contact 105b and extends therefrom to the temperature sensor 130a. The electrical connectors 107a. 107b in this illustrated embodiment each include a wire, but other types of electrical connectors are possible. Also, each electrical contact 105a. 105b has a dedicated electrical connector 107a. 107b in this illustrated embodiment, but a single electrical connector may be used.

The liquid source's electrical contacts 105a. 105b are located opposite to one another on an interior-facing surface 104i of the liquid source 104a adjacent to and below the bottom surface 104b. The electrical contacts 105a. 105b are located on the liquid source 104a at a location that allows the electrical contacts 105a. 105b to be in contact with corresponding electrical contacts 109a. 109b of the base 106a with the liquid source 104a mated with the base 106a. The base's electrical contacts 109a. 109b in this illustrated embodiment are located opposite to one another on an exterior-facing surface 106e of the base 106a below a top surface 106t of the base 106. The base's top surface 106t is configured to engage the liquid source's bottom surface 106b with the liquid source 104a mated with the base 106a. The electrical contacts 105a. 105b being located on the interior-facing surface 104i may facilitate safety by obscuring or hiding the electrical contacts 105a. 105b when the electrical contacts 105a. 105b are conducting electricity with the liquid source 104a mated with the base 106a. Other locations of the liquid source's electrical contacts 105a. 105b and the base's electrical contacts 107a. 107b are possible, for example the liquid source's electrical contacts 105a. 105b being on the liquid source's bottom surface 104b and the base's electrical contacts 107a. 107b being on a top surface 106t of the base 106a or, for another example, the liquid source's electrical contacts 105a. 105b being next to one another on the liquid source's interior-facing surface 104i and the base's electrical contacts 107a. 107b being next to one another on the base 106a.

The liquid source's electrical contacts 105a. 105b each include a metal plate in this illustrated embodiment, but other types of metallic or otherwise conductive electrical contacts may be used. The base's electrical contacts 109a. 109b each include a metal pin in this illustrated embodiment, but other types of metallic or otherwise conductive electrical contacts may be used.

The base's electrical contacts 109a. 109b are each configured to be operatively coupled to a power source configured to provide power to the carbonation system, e.g., an on-board battery, an electrical outlet via a power cord, etc. Thus, with the carbonation system powered on, power is provided to the base's electrical contacts 109a. 109b. With power provided to the base's electrical contacts 109a. 109b and with the liquid source 104a mated with the base 106a, power is provided to the liquid source's electrical contacts 105a. 105b via their contact with the base's electrical contacts 109a. 109b. Power is thereby provided to the temperature sensor 130a via the electrical conductors 107a, 107b with the carbonation system powered on and the liquid source 104a mated with the base 106b. The temperature sensor 130a being powered triggers the temperature sensor 130a to detect temperature of the liquid in the liquid source 104a and transmit one or more signals indicative of the detected temperature to a processor of the carbonation system via one or both of the electrical conductors 107a, 107b and one or both pairs of electrical contacts 105a/107a, 105b/107b. In other words, the liquid source's electrical contacts 105a, 105b being in contact with the base's electrical contacts 107a, 107b closes an electrical circuit including the temperature sensor 130a so as to allow the temperature sensor's measured temperature to be communicated to the carbonation system's processor for use as described herein. Such communication occurs substantially instantaneously with the closing of the electrical circuit, thereby decreasing an amount of time the user has to wait before receiving notification of the liquid's temperature.

Release of the liquid source 104a from the base 106a is configured to automatically open the electrical circuit, thereby readying the carbonation system for another temperature measurement at a later time in response to the liquid source 104a being coupled again to the base 106a.

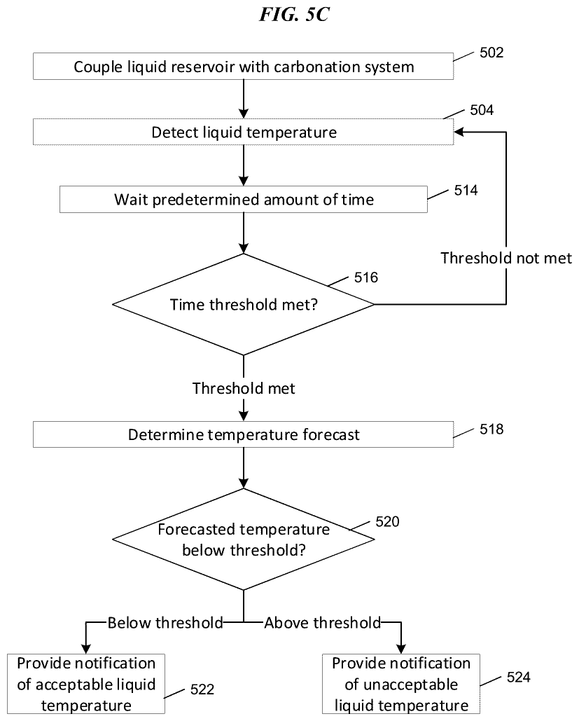

FIG. 5A illustrates one embodiment of a method 500 of detecting liquid temperature for a carbonation system. The method 500 is described with respect to the carbonation system 100 of FIGS. 1A-1H for ease of explanation but can be similarly performed with respect to another carbonation system (e.g., the carbonation system of FIGS. 1I-IL, the carbonation system 200 of FIGS. 2A-2B, the carbonation system 300 of FIGS. 3A-3B, etc.).

The method 500 includes coupling 502 the liquid reservoir 104 with the carbonation system 100, e.g., coupling the liquid reservoir 104 with the base 106. The coupling 502 of the liquid reservoir 104 with the carbonation system 100 activates the activator (or closes the electrical circuit, as in the embodiment of FIGS. 1I-1L), thereby triggering the temperature sensor 130 to detect 504 temperature of the liquid flowing out of the liquid source 104 and transmit to the processor one or more signals indicative of the detected temperature. The processor uses the one or more signals from the temperature sensor 130 to determine whether the liquid temperature is below a predetermined threshold temperature and cause a notification to be provided 506 based on the determination.

FIG. 5B illustrates one embodiment of the method 500 in which the processor considers an actual temperature of the liquid in determining whether the liquid's temperature is below the predetermined threshold temperature. As shown in FIG. 5B, after the liquid source 104 has been coupled 502 with the carbonation system 100, the liquid temperature is detected 504 after waiting 503 for a predetermined amount of time. The predetermined amount of time is defined by an amount of time needed to detect accurate temperature for the particular temperature sensor 130 being used. Passage of the predetermined amount of time can be determined using a clock or other timer communicatively coupled with the processor. The processor receives one or more signals from the temperature sensor 130 indicative of the detected temperature and determines 508 whether the detected temperature is below a predetermined threshold temperature. If the detected temperature is determined 508 to be below the predetermined threshold temperature, the processor causes a notification to be provided 510, indicating that the liquid is of an acceptable temperature for forming a carbonated fluid. If the detected temperature is determined 508 to not be below the predetermined threshold temperature, the processor causes a notification to be provided 512, indicating that the liquid is not of an acceptable temperature for forming a carbonated fluid.

FIG. 5C illustrates one embodiment of the method 500 in which a forecasted temperature of the liquid is considered by the processor in determining whether the liquid's temperature is below the predetermined threshold temperature. As shown in FIG. 5C, after the liquid source 104 has been coupled 502 with the carbonation system 100 and the liquid temperature has been detected 504, the processor receives one or more signals from the temperature sensor 130) indicative of the detected temperature. After waiting 514 for a predetermined amount of time, the processor determines 516 if a predetermined threshold amount of time has been met. Passage of the predetermined amount of time can be determined using a clock or other timer communicatively coupled with the processor. The predetermined amount of time corresponds to an amount of time between successive temperature measurements by the temperature sensor 130 for transmission to the processor. The predetermined threshold amount of time corresponds to a total amount of time in which temperature measurements are taken before the processor determines 518, a forecasted temperature of the liquid. The processor repeatedly receives one or more signals from the temperature sensor 130 indicative of successively detected temperatures until the predetermined threshold amount of time has been met. Once the processor has received all of the detected temperatures, the processor determines 518, the forecasted temperature of the liquid, e.g., using a forecasting model, and determines 520, whether the forecasted temperature is below a predetermined threshold temperature. If the forecasted temperature is determined 520 to be below the predetermined threshold temperature, the processor causes a notification to be provided 522, indicating that the liquid is of an acceptable temperature for forming a carbonated fluid. If the forecasted temperature is determined 520 to not be below the predetermined threshold temperature, the processor causes a notification to be provided 524 indicating that the liquid is not of an acceptable temperature for forming a carbonated fluid.

The subject matter described herein can be implemented in analog electronic circuitry, digital electronic circuitry, and/or in computer software, firmware, or hardware, including the structural means disclosed in this specification and structural equivalents thereof or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, algorithm, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code).

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices. (e.g., EPROM, EEPROM, and flash memory devices). The processor and the memory can be supplemented by, or incorporated in, special purpose logic circuitry.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor-readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor). The modules described herein can be combined, integrated, separated, and/or duplicated to support various applications. Also, a function described herein as being performed at a particular module can be performed at one or more other modules and/or by one or more other devices instead of or in addition to the function performed at the particular module.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

What is claimed is:

1. A system comprising:
a liquid reservoir configured to supply a liquid to a chamber of a carbonation system configured to form a carbonated fluid in the chamber;
a temperature sensor configured to sense a temperature of the liquid; and
a processor configured to
receive a signal from the temperature sensor that is indicative of the sensed temperature,
determine, based on the received signal, whether the sensed temperature is below a predetermined threshold temperature; and
cause a notification to be provided to a user indicative of whether the sensed temperature is below the predetermined threshold temperature.

2. The system of claim 1, wherein the liquid reservoir is configured to be releasably coupled to the carbonation system.

3. The system of claim 2, further comprising a switch configured to be activated in response to the liquid reservoir being releasably coupled to the carbonation system:
wherein the activation of the switch is configured to trigger the temperature sensor to transmit the signal to the processor.

4. The system of claim 2, wherein the releasable coupling of the liquid reservoir to the carbonation system is configured to close an electrical circuit that includes the temperature sensor and thereby trigger the temperature sensor to transmit the signal to the processor.

5. The system of claim 4, wherein the temperature sensor is attached to the liquid reservoir; and
the liquid reservoir is configured to be releasably coupled to a dock of the carbonation system such that electrical contacts attached to the liquid reservoir electrically mate with electrical contacts attached to the dock, the mating of the electrical contacts closing the electrical circuit.

6. The system of claim 1, wherein determining whether the sensed temperature is below the predetermined threshold temperature includes comparing the predetermined threshold temperature with a forecasted future temperature of the liquid; and
the processor is configured to determine the forecasted future temperature based on the received signal.

7. The system of claim 6, wherein the signal from the temperature sensor includes a plurality of signals each indicative of the temperature of the liquid at a successive time, with the successive times defining a time period; and
the forecasted future temperature is for a time after the time period.

8. The system of claim 1, wherein determining whether the sensed temperature is below the predetermined threshold temperature includes comparing the predetermined threshold temperature with an actual temperature of the liquid.

9. The system of claim 1, wherein the notification includes at least one of an audible notification and a visual notification.

10. The system of claim 9, wherein the notification includes at least the visual notification:
the visual notification includes a first illuminated light if the sensed temperature is determined to be below the predetermined threshold temperature; and
the visual notification includes a second, different illuminated light if the sensed temperature is determined to be above the predetermined threshold temperature.

11. The system of claim 9, wherein the notification includes at least the visual notification; and
the visual notification includes at least one of text and a symbol provided on a user interface.

12. A method comprising:
receiving, at a processor, a signal from a temperature sensor that is indicative of a sensed temperature of a liquid in a liquid reservoir, the liquid in the liquid reservoir being configured to be supplied to a chamber of a beverage carbonation system in which a carbonated fluid is formed;
determining, using the processor and based on the received signal, whether the sensed temperature is below a predetermined threshold temperature; and
causing, using the processor, a notification to be provided to a user indicative of whether the sensed temperature is below the predetermined threshold temperature.

13. The method of claim 12, wherein activation of a switch triggers the temperature sensor to transmit the signal to the processor:
the liquid reservoir is configured to be releasably coupled to the carbonation system; and
the switch is activated in response to the liquid reservoir being releasably coupled to the carbonation system.

14. The method of claim 12, wherein the liquid reservoir is configured to be releasably coupled to the carbonation system; and
the releasable coupling of the liquid reservoir to the carbonation system closes an electrical circuit that includes the temperature sensor and thereby triggers the temperature sensor to transmit the signal to the processor.

15. The method of claim 12, wherein determining whether the sensed temperature is below the predetermined threshold temperature includes comparing the predetermined threshold temperature with a forecasted future temperature of the liquid; and
the forecasted future temperature is determined based on the received signal.

16. The method of claim 15, wherein the signal from the temperature sensor includes a plurality of signals each indicative of the temperature of the liquid at a successive time, with the successive times defining a time period; and
the forecasted future temperature is for a time after the time period.

17. The method of claim 12, wherein determining whether the sensed temperature is below the predetermined threshold temperature includes comparing the predetermined threshold temperature with an actual temperature of the liquid.

18. The method of claim 12, wherein the notification includes at least one of an audible notification and a visual notification.

19. The method of claim 18, wherein the notification includes at least the visual notification:
the visual notification includes a first illuminated light if the sensed temperature is determined to be above the predetermined threshold temperature; and
the visual notification includes a second, different illuminated light if the sensed temperature is determined to be above the predetermined threshold temperature.

20. The method of claim 18, wherein the notification includes at least the visual notification; and
the visual notification includes at least one of text and a symbol provided on a user interface.
